(19) United States
(12) Patent Application Publication
(10) Pub. No.: US 2006/0251472 A1
(43) Pub. Date: Nov. 9, 2006

(54) Shaft-hub connection

(75) Inventor: Roland Stauber, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 10/555,283

(22) PCT Filed: Apr. 27, 2004
(86) PCT No.: PCT/EP04/04417

§ 371 Date: Dec. 12, 2005

(30) Foreign Application Priority Data
May 2, 2003 (DE) 103 19 629.3

(51) Int. Cl. F16D 1/08

(52) U.S. Cl. 403/345

(57) ABSTRACT

A permanent shaft-hub connection for toothed wheels for a transmission shaft (1), each toothed wheel being fixed to the shaft by way of shrinkage fits (3, 5). The directly adjacent toothed wheels (2, 4) are embodied in such a way that they partially superimposed the adjacent areas thereof being also connected by shrinkage fit (6).

This application is a national stage completion of PCT/EP2004/004417 filed Apr. 27, 2004 which claims priority from German Application Serial No. 103 19 629.3 filed May 2, 2003.

### FIELD OF THE INVENTION

This invention relates to a permanent shaft-hub connection, especially for toothed wheels on a transmission shaft, each toothed wheel being fixed to the shaft by way of a shrinkage fit.

### BACKGROUND OF THE INVENTION

Torque-transmitting shafts with toothed wheels situated thereon are widely known in transmission designs. Multiple possibilities exist for fixing the toothed wheels on the shaft. The types of this connection have been divided in elementary shaft-hub connections and combined shaft-hub connections.

To the form-locking elementary shaft-hub connections belong the spline shaft connection, the serrated connection, the involute spline connection, the polygon spline connection, the fitted key connection and the pin connection.

To the force-locking elementary shaft-hub connections belong the pressure and shrinkage connection, the spline connection, the clamping ring connection, the clamping plate connection and the star-disc connection.

To the material-locking elementary connections along the welded connection, the soldered connection and the bonding connection.

To the combined shaft-hub connections belong as non-material locking combined shaft-hub connections, the press-knurling connection and the pressure point locking connection.

To the non-material locking-material locking combined shaft-hub connections belong the pressure-bonding connection, the pressure-welding connection and the pressure-soldering connection.

Finally, the weld-soldering connection also belongs to the material-locking combined shaft-hub connection.

All these known connection types have in common that they still are affected with the disadvantage that they cannot fully prevent the movements of the toothed wheel on the shaft. Despite optimized designs, so-called micromigrations occur, for example, in load peaks. Especially in transmission where exact coordinations of the toothings of different toothed wheels play a decisive part, those micromigrations of the toothed wheels on the shaft absolutely have to be prevented. This particularly applies to transmissions with load distribution to two or more countershafts, since here an absolutely precise positioning is an irrevocable condition.

Although in such transmissions, the conventional technology of welding the toothed wheels with the shaft results in relatively good material-locking connection, it is still associated with the disadvantage of a not inconsiderable tolerance which leads to a certain positioning error as a result of a thermal warping produced by the welding process. The cited fitted key connection results in a greater positioning error and in a weakening of the parts consisting of shaft and toothed wheel.

To prevent the disadvantages of the micromigration, DE-A-196 20 330 already has proposed connecting the toothed wheel with the shaft by way of a shrinkage fit and, in addition, holding it by a form-locking connection to prevent movements. The form-locking connection can be a pin connection wherein the pin either engages partly in the shaft or entirely penetrates it.

A connection of a toothed wheel with a self-rotating shaft for torque transmission by way of a shrinkage fit without additional form-locking part, be it a fitted key, engaging gears or a pinned fitting (also called shrinkage fit bond) is used not only in transmissions for motor vehicles, but quite generally in a multiplicity of machines.

DE-A-198 50 383 thus describes a hydrodynamic retarder which is downstream of a transmission in a motor vehicle and has one rotor located in a retarder housing and one stator located in a retarder housing, which are supported on the housing by way of a fixing device. One measuring device on the housing is provided for the retarder brake torque which is energized by the fixing device; the measuring device being connected with a control device.

The measuring device on the retarder housing can be designed as a reaction cam which directly energizes the measuring device or a stator projection in the housing which is desired by way of a shrinkage fit.

DE-A-101 34 245 finally describes a transmission having one inner power distribution consisting of a large toothed wheel connected with an input shaft or with an output shaft and surrounded by a multiplicity of pinions the toothed pinions of which mesh therewith and which can be used both as a step up and as a reduction gear. To transmit the torques of the rotor shaft to a transmission hollow shaft, a shrinkage disc is provided. The transmission is especially adequate for driving generations by the rotors of a windmill installation.

The problem to be solved by this invention is to provide a permanent shaft-hub connection, especially for toothed wheels on a transmission shaft with which the torque transmitting capacity is considerably increased.

### SUMMARY OF THE INVENTION

The invention therefor provides that toothed wheels disposed directly side-by-side on the shaft be designed so as to be partly superimposed and that the superimposed abutting areas of the toothed wheels be, likewise, interconnected by a shrinkage fit.

The superimposed areas of the adjacent toothed wheels are advantageously designed by steps.

By virtue of the inventive development, the torque transmitting capacity of the toothed wheels interconnected by way of the shrinkage fit can be considerably increased, since the added shrinkage fit connection between the toothed wheels results in a radial reinforcement of the hub of the toothed wheels thus reducing the expansion thereof.

One other advantage of the inventive development is to be seen in that the bending resistance of the shaft is altogether increased.

The invention is explained in detail herebelow with reference to an advantageous embodiment diagrammatically shown.

### BRIEF DESCRIPTION OF THE DRAWINGS

The invention will now be described, by way of example, with reference to the accompanying drawings in which:

FIG. 1 is a diagrammatic representation of a shaft-hub connection showing only the parts needed for understanding the invention

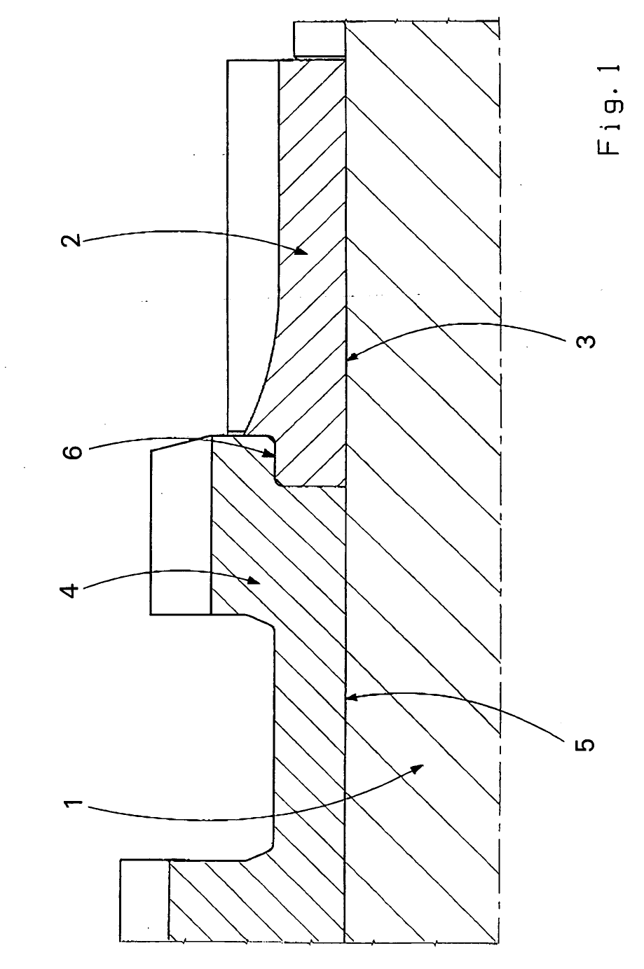

### DETAILED DESCRIPTION OF THE INVENTION

Upon the shaft 1 of a transmission, which specifically is not a transmission exclusively for a motor vehicle, one toothed wheel 2 is situated by way of a shrinkage fit 3, that is, firmly connected with the shaft. A second toothed wheel 4, which, in the embodiment chosen, is designed as a double toothed wheel, is situated directly adjacent to the toothed wheel 2 and, likewise, firmly connected with the shaft 1 via a shrinkage fit 5.

The toothed wheels 2 and 4 are now designed so as to produce superimposed areas which, likewise, are interconnected by way of a shrinkage fit 6. As can be seen in the FIGURE, the superimposed areas are advantageously designed by steps.

With this increase or enlargement of the shrinkage fit surface, the torque transmitting capacity of both toothed wheels 2 and 4 can be clearly increased; the additionally provided shrinkage fit 6, on one hand, reinforces the hub of the toothed wheel 2 in radial direction thereby preventing or reducing the expansion thereof whereby a partial area of the shrinkage fit 3 is strengthened.

Besides, a coupling of both toothed wheels acts upon the shrinkage fit 6, which contributes to increasing the torque transmitting capacity. Another very positive effect is the increase to bending resistance of the whole shaft.

Let it be emphasized that this constructional principle can be applied to the most different shrinkage fit designs such as to the shrinkage bonding fit.

### REFERENCE NUMERALS

1 shaft
2 toothed wheel
3 shrinkage fit
4 toothed wheel
5 shrinkage fit
6 shrinkage fit

1-2. (canceled)

3. A permanent shaft-hub connection, especially for toothed wheels on a transmission shaft, each toothed wheel (2, 4) is fastened on the shaft (1) by way of a shrinkage fit (3, 5), the toothed wheels directly disposed side-by-side are partly superimposed and superimposed areas abutting on each other of the toothed wheels (2,4) are likewise interconnected by way of a shrinkage fit (6).

4. The permanent shaft hub connection according to claim 3, wherein the superimposed areas abutting on each other of both the toothed wheels are designed as steps.

5. A permanent shaft-hub connection comprising: a central shaft, at least a first and a second toothed wheel hub secured to the central shaft by a shrinkage fit, the first toothed wheel hub being adjacent to the second toothed wheel hub, the first toothed wheel hub having a first section superimposing a second section of the second toothed wheel hub, the first section and the second section being secured to each other by a shrinkage fit.
